(19) United States
(12) Patent Application Publication
(10) Pub. No.: US 2018/0232032 A1
(43) Pub. Date: Aug. 16, 2018

(54) ELECTRONIC APPARATUS AND POWER MANAGEMENT METHOD FOR DYNAMICALLY ALLOCATING POWER BUDGET BETWEEN HEAT SOURCES OF ELECTRONIC APPARATUS

(71) Applicant: MEDIATEK INC., Hsin-Chu (TW)

(72) Inventors: Wei-Ting Wang, Taipei City (TW); Yingshiuan Pan, Kaohsiung City (TW); Han-Lin Li, Taoyuan City (TW); Chih-Yuan Hsiao, New Taipei City (TW); Che-Chuan Hu, Kaohsiung City (TW)

(21) Appl. No.: 15/432,945

(22) Filed: Feb. 15, 2017

(51) Int. Cl. G06F 1/32; G06F 1/28

(52) U.S. Cl. CPC G06F 1/324; G06F 1/3215; G06F 1/28

(57) ABSTRACT

A power management method for an electronic apparatus is provided. The electronic apparatus includes a plurality of heat sources. The power management method includes the following steps: detecting a temperature of the electronic apparatus; detecting a power of the electronic apparatus; identifying an operating scenario of the electronic apparatus; and referring to the detected temperature, the detected power and the operating scenario to determine whether to allocate a power budget between the heat sources.

### BACKGROUND

The disclosed embodiments of the present invention relate to power budget allocation, and more particularly, to a power management method for selectively allocating a power budget between a plurality of heat sources of an electronic apparatus according to whether a user experience with an application on the electronic apparatus will be sustained, and related electronic apparatus.

To prevent performance degradation resulting from overheating, a conventional electronic apparatus enters a thermal throttling mode when a temperature of the electronic apparatus exceeds a predetermined thermal threshold. For example, thermal throttling is triggered when a temperature of a circuit board of the electronic apparatus exceeds the predetermined thermal threshold.

However, when a plurality of circuit elements of the electronic apparatus operates concurrently, a user experience with an application on the electronic apparatus will be degraded due to early thermal throttling. For example, in a case where the electronic apparatus executes a game application and a charge process concurrently, the temperature of the circuit board is raised quickly because a temperature rise of the circuit board comes from a central processing unit (executing the game application) and a charging circuit (executing the charge process), and the temperature of the circuit board quickly reaches the predetermined thermal threshold accordingly. Hence, the electronic apparatus will throttle the central processing unit earlier, which results in degradation of a user's viewing experience.

Thus, there is a need for a novel power management mechanism to solve the aforementioned problems.

### SUMMARY

In accordance with exemplary embodiments of the present invention, a power management method for selectively allocating a power budget between a plurality of heat sources of an electronic apparatus according to whether a user experience with an application on the electronic apparatus will be sustained, and related electronic apparatus are proposed to solve the above-mentioned problems.

According to an embodiment of the present invention, an exemplary power management method for an electronic apparatus is disclosed. The electronic apparatus comprises a plurality of heat sources. The exemplary power management method comprises the following steps: detecting a temperature of the electronic apparatus; detecting a power of the electronic apparatus; identifying an operating scenario of the electronic apparatus; and referring to the detected temperature, the detected power and the operating scenario to determine whether to allocate a power budget between the heat sources.

According to an embodiment of the present invention, an exemplary electronic apparatus is disclosed. The exemplary electronic apparatus comprises a plurality of heat sources, a temperature sensor, a power sensor and a system power allocation circuit. The temperature sensor is arranged for detecting a temperature of the electronic apparatus. The power sensor is arranged for detecting a power of the electronic apparatus. The system power allocation circuit is coupled to the heat sources, the temperature sensor and power sensor. The system power allocation circuit is arranged for identifying an operating scenario of the electronic apparatus, and referring to the detected temperature, the detected power and the operating scenario to determine whether to allocate a power budget between the heat sources.

By dynamically allocating a system power budget of an electronic apparatus between a plurality of heat sources thereof, the proposed power management mechanism may not only maintain a primary user experience but also maximize a secondary user experience, thereby providing a good overall user experience of the electronic apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exemplary electronic apparatus according to an embodiment of the present invention.

FIG. 2 is a diagram illustrating an implementation of the electronic apparatus shown in FIG. 1.

FIG. 3 illustrates variations in a circuit board temperature and a frame rate due to power budget allocation employed by the electronic apparatus shown in FIG. 2 according to an embodiment of the present invention.

FIG. 4 illustrates an exemplary system power associated with the power budget allocation shown in FIG. 3 according to an embodiment of the present invention.

FIG. 5 illustrates variations in a circuit board temperature and power consumption in the electronic apparatus shown in FIG. 2 according to an embodiment of the present invention.

FIG. 6 is a flow chart of an exemplary power management method for an electronic apparatus according to an embodiment of the present invention.

FIG. 7 is a flow chart of an exemplary power management method for an electronic apparatus according to an embodiment of the present invention.

FIG. 8 is an implementation of the electronic apparatus shown in FIG. 1.

FIG. 9 is a flow chart of an exemplary method employed by the system power allocation circuit shown in FIG. 8 to determine whether to allocate the power budget according to an embodiment of the present invention.

FIG. 10 is a flow chart illustrating an implementation of the step of determining if the user experience with the application is likely to be degraded shown in FIG. 9 according to an embodiment of the present invention.

FIG. 11 is a flow chart illustrating an implementation of the step of determining if the exit criterion is met shown in FIG. 9 according to an embodiment of the present invention.

FIG. 12 is a flow chart illustrating an exemplary method for determining a heat source priority table according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “coupled” is intended to mean either an indirect or direct electrical connection. Accordingly, if one device is electrically connected to another device, that connection may be through a direct electrical connection, or through an indirect electrical connection via other devices and connections.

The proposed power management mechanism may refer to system information (e.g. temperature and power information) and/or a current operating scenario of an electronic apparatus to detect if a user experience with an application (e.g. a primary user experience, or a user experience with a foreground application) running on the electronic apparatus is sustainable, and accordingly allocate a system power budget of the electronic apparatus between a plurality of heat sources thereof before the user experience degrades (e.g. before thermal throttling is triggered). By way of example but not limitation, the proposed power management mechanism may allocate more power to a heat source executing a high priority application and/or reduce power allocated to a heat source executing a low priority application. Hence, the proposed power management mechanism may provide a good overall user experience of the electronic apparatus under the system power budget. Further description is provided below.

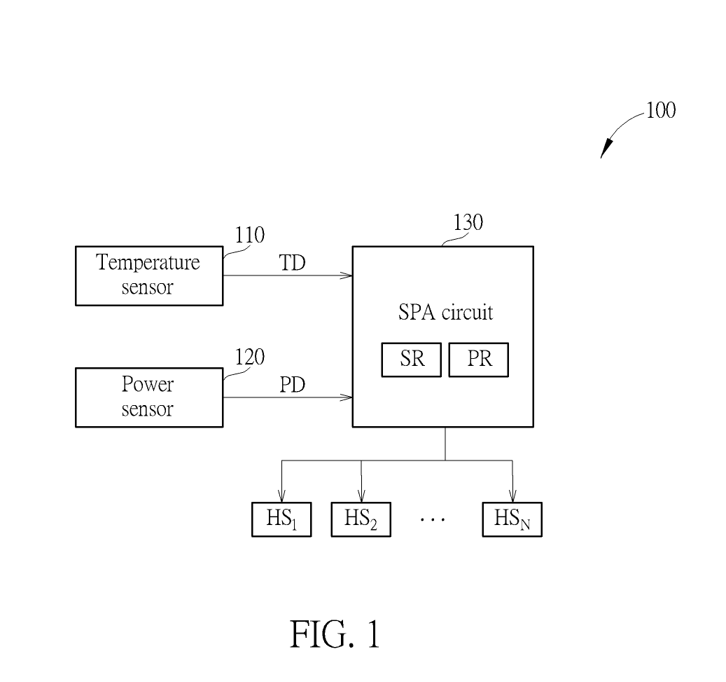

FIG. 1 illustrates an exemplary electronic apparatus according to an embodiment of the present invention. The electronic apparatus 100 may include a plurality of heat sources HS₁-HS_{N}, wherein each of the heat sources HS₁-HS_{N} is a circuit arranged for executing at least one application to provide a user experience associated with the at least one application. By way of example but not limitation, each of the heat sources HS₁-HS_{N} may be a processor module (which may include a central processing unit (CPU) and/or a graphics processing unit (GPU)), a wireless network module (e.g. a wireless fidelity (WiFi) module), a charging module, a modem module, a backlight module or a camera module.

The electronic apparatus 100 may set a thermal threshold. When a detected temperature of the electronic apparatus 100 exceeds the thermal threshold, the electronic apparatus 100 may trigger thermal throttling to decrease processing performance thereof. For example, when a chassis temperature (or a circuit board temperature) of the electronic apparatus 100 exceeds the thermal threshold, the electronic apparatus 100 may trigger thermal throttling to decrease a clock frequency thereof. In addition, as power consumption of each heat source may increase the detected temperature of the electronic apparatus 100, the thermal threshold may correspond to a power budget (a system power budget) shared by the heat sources HS₁-HS_{N}, wherein when the heat sources HS₁-HS_{N} require more power than the power budget, the electronic apparatus 100 may trigger thermal throttling.

To avoid degradation of a user experience (e.g. early thermal throttling) due to mutual interference between the heat sources HS₁-HS_{N}, the electronic apparatus 100 may further include, but is not limited to, a temperature sensor 110, a power sensor 120 and a system power allocation (SPA) circuit 130, wherein the electronic apparatus 100 may refer to system information (including temperature and power information) and/or a current operating scenario to selectively/adaptively allocate the power budget between the heat sources HS₁-HS_{N}, and accordingly maintain a good overall user experience under the power budget.

The temperature sensor 110 may detect a temperature TD of the electronic apparatus 100, wherein the detected temperature TD may be, but is not limited to, a junction temperature of a die/chip, a temperature of a circuit board, a temperature of a battery device or a temperature of a chassis of the electronic apparatus 100. The power sensor 120 may detect a power PD of the electronic apparatus 100. By way of example but not limitation, the power sensor 120 may directly measure power consumption of the electronic apparatus 100 to determine the power PD (e.g. the power sensor 120 may be implemented by a power meter). In another example, the power sensor 120 may calculate the power consumption of the electronic apparatus 100 according to the system information (e.g. a clock frequency and an operating performance point of a CPU) to thereby determine the power PD (e.g. the power sensor 120 may be implemented by a processor). In yet another example, the power sensor 120 may detect other system information associated with the power consumption of the electronic apparatus 100 (e.g. network throughput or a frame rate) to determine the power PD in an indirect manner. In other words, the detected power PD may be an index indicating power information.

The SPA circuit 130 is coupled to the heat sources HS₁-HS_{N}, the temperature sensor 110 and the power sensor 120, and may be arranged for identifying an operating scenario SR of the electronic apparatus 100, and referring to the detected temperature TD, the detected power PD and the operating scenario SR to determine whether to allocate the power budget between the heat sources HS₁-HS_{N}. For example, in a case where the electronic apparatus 100 uses the heat source HS₁ to run an application (e.g. using a processor module including a CPU and a GPU to execute a game application), the SPA circuit 130 may refer to the detected temperature TD, the detected power PD and the operating scenario SR to determine whether a user experience with the application is likely to be degraded, and accordingly determine whether to allocate the power budget between the heat sources HS₁-HS_{N}. When it is determined that the user experience with the application is likely to be degraded, the SPA circuit 130 may throttle the heat source HS₂ (e.g. a charging module) to allocate the power budget between the heat sources HS₁-HS_{N}, wherein the heat source HS₁ is more required than the heat source HS₂ to run the application. To put it differently, the SPA circuit 130 may maintain the user experience associated with a primary heat source (the heat source HS₁) by reducing power allocated to a secondary heat source (the heat source HS₂), so as to maintain a good overall user experience of the electronic apparatus 100 under the power budget.

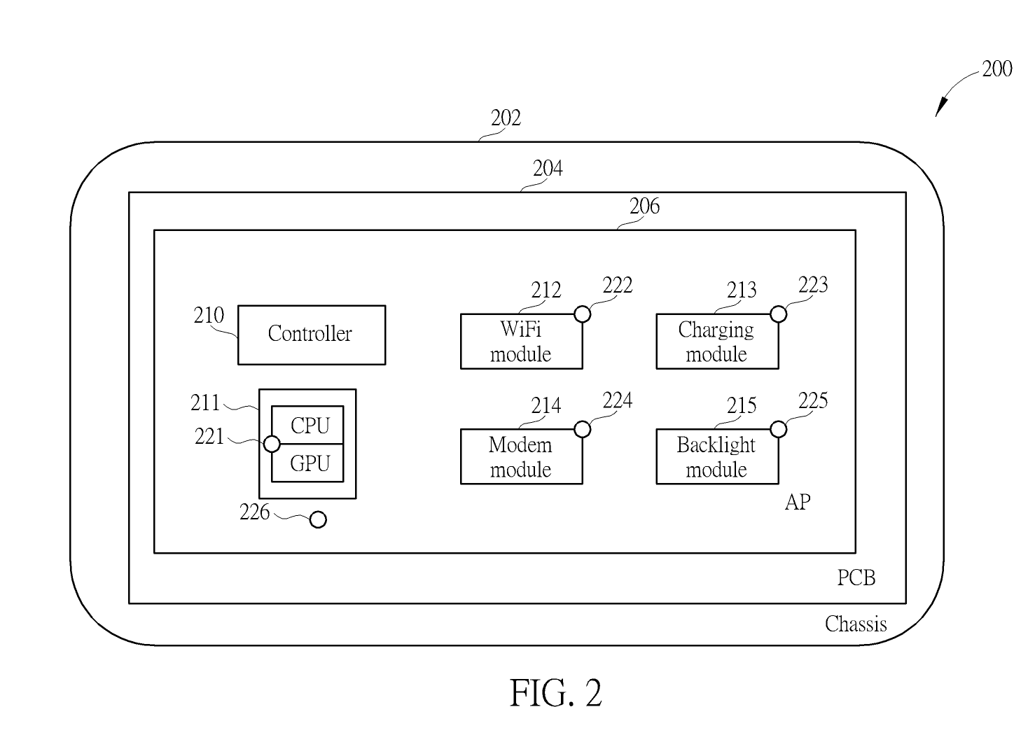

To facilitate an understanding of the present invention, an exemplary implementation is given in the following for further description of the proposed power management mechanism. It should be noted that other circuit implementations employing the architecture shown in FIG. 1 are feasible. Please refer to FIG. 2, which is a diagram illustrating an implementation of the electronic apparatus 100 shown in FIG. 1. In this implementation, the electronic apparatus 200 may be implemented by a portable electronic apparatus such as a mobile phone or a tablet computer, and may include, but is not limited to, a chassis 202, a printed circuit board (PCB) 204, a controller 210, a processor module 211 (including a CPU and a GPU), a wireless fidelity (WiFi) module 212, a charging module 213, a modem module 214 and a backlight module 215. The controller 210, the processor module 211, the WiFi module 212, the charging module 213, the modem module 214 and the backlight module 215 may be integrated within an application processor (AP) 206 disposed on the PCB 204. However, this is not meant to be a limitation of the present invention.

Additionally, at least a portion of the heat sources HS₁-HS_{N} shown in FIG. 1 may be implemented by the processor module 211, the WiFi module 212, the charging module 213, the modem module 214 and the backlight module 215. The processor module 211 may execute application(s) related to image/video processing and accordingly provide a user experience associated with a frame rate; the WiFi module 212 may execute application(s) related to data transmission in a wireless network and accordingly provide a user experience associated with a wireless transmission rate; the charging module 213 may execute application(s) related to power supply and accordingly provide a user experience associated with a charging rate; the modem module 214 may execute application(s) related to data transmission in a mobile network and accordingly provide a user experience associated with a network transmission rate; and the backlight module 215 may execute application(s) related to light supply and accordingly provide a user experience associated with screen brightness.

The electronic apparatus 200 may further include a plurality of temperature sensors 221-226, wherein the temperature sensor 110 shown in FIG. 1 may be implemented by one of the temperature sensors 221-226. The temperature sensor 221 may detect a die junction temperature of the processor module 211, the temperature sensor 222 may detect a die junction temperature of the WiFi module 212, the temperature sensor 223 may detect a die junction temperature of the charging module 213, the temperature sensor 224 may detect a die junction temperature of the modem module 214, the temperature sensor 225 may detect a die junction temperature of the backlight module 215, and the temperature sensor 226 may detect a temperature of the PCB 204. In addition, the electronic apparatus 200 (or the AP 206) may determine/estimate a temperature of the chassis 202 according to detected temperature(s) of at least one of the temperature sensors 221-226. Please note that, in one implementation, the AP 206 may determine/estimate the temperature of the PCB 204 according to detected temperature(s) of at least one of the temperature sensors 221-225.

Further, the processor module 211 may calculate a power (power consumption) of the electronic apparatus 200 according to the system information (e.g. a CPU clock frequency, an operating performance point (OPP) and/or a frame rate), and the controller 210 may refer to the detected temperature (s) and the detected power to perform power budget allocation between the processor module 211, the WiFi module 212, the charging module 213, the modem module 214 and the backlight module 215. In other words, the power sensor 120 and the SPA circuit 130 shown in FIG. 1 may be implemented by the CPU of the processor module 211 and the controller 210, respectively.

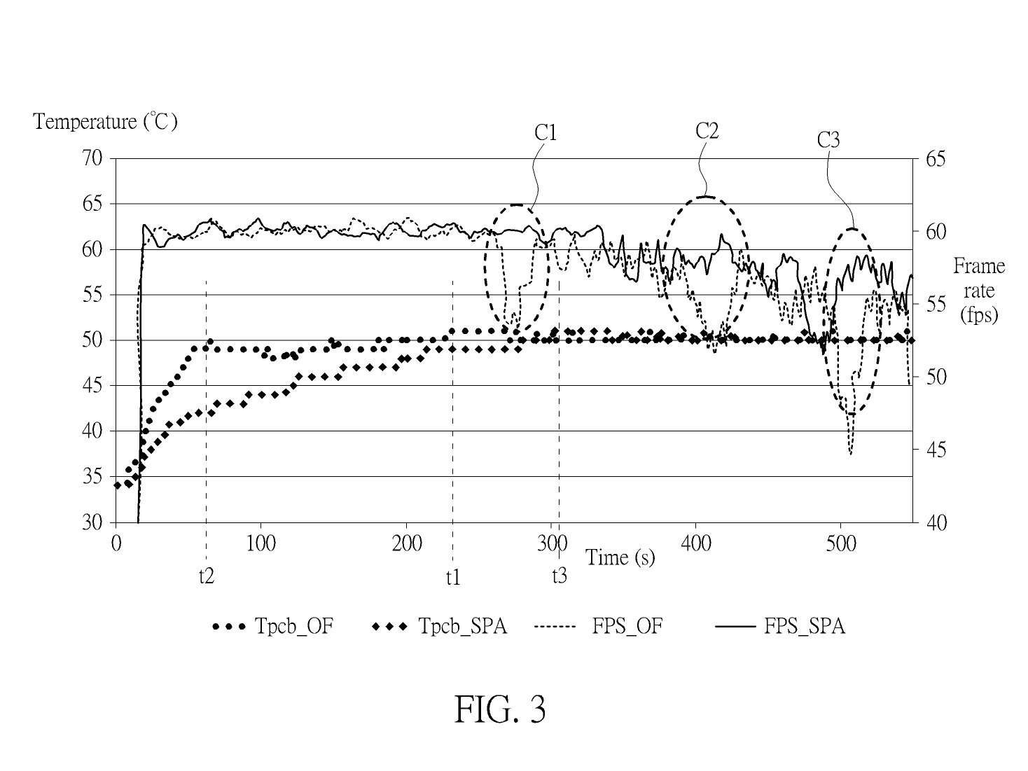

For illustrative purposes, the following describes an implementation where the electronic apparatus 200 operates in an exemplary operating scenario where a game application and a fast-charging application are executed. However, this is not meant to be a limitation of the present invention. Please refer to FIG. 3 in conjunction with FIG. 2. FIG. 3 illustrates variations in a circuit board temperature and a frame rate due to power budget allocation employed by the electronic apparatus 200 shown in FIG. 2 according to an embodiment of the present invention. In this embodiment, the user plays a game on the electronic apparatus 200 while charging the electronic apparatus 200, wherein the game imposes a heavy CPU/GPU load (e.g. a three-dimensional (3D) game), and the electronic apparatus 200 may utilize the processor module 211 to run a game application and utilize the charging module 213 to run a fast-charging application. The controller 210 may identify that the electronic apparatus 200 operates in an operating scenario where the game application and the fast-charging application are executed. Additionally, in a case where the electronic apparatus 200 has enough battery charge, the controller 210 may identify a user experience with the game application as a primary user experience of the electronic apparatus 200, and identify a user experience with the fast-charging application as a secondary user experience of the electronic apparatus 200.

Firstly, consider a case where the electronic apparatus 200 operates without employing the power budget allocation. As having each of the game application and the fast-charging application execute on the electronic apparatus 200 will heat up the PCB 204, the temperature of the PCB 204 (represented by a circuit board temperature Tpcb_OF) rises rapidly, resulting in early thermal throttling (e.g. the circuit board temperature Tpcb_OF exceeds a thermal threshold 50° C. at a point in time t1) and performance degradation. Specifically, as thermal throttling reduces power allocated to the processor module 211, the processor module 211 cannot meet computational power requirements of complex scenes C1-C3, and a frame rate of the electronic apparatus 200 (represented by a frame rate FPS_OF) drops accordingly.

In a case where the electronic apparatus 200, by contrast, employs the power budget allocation, when determining that the user experience with the game application is likely to be degraded, the controller 210 may determine to throttle the charging module 213 to maintain the user experience with the game application (the primary user experience). By way of example but not limitation, when determining that the temperature of the PCB 204 (represented by a circuit board temperature Tpcb_SPA) exceeds a predetermined temperature (less than the thermal threshold 50° C., such as 40° C.) and the frame rate of the electronic apparatus 200 (represented by a frame rate FPS_SPA) exceeds a predetermined frame rate 60 fps (i.e. a power of the processor module 211 is greater than a predetermined power) at a point in time t2, the controller 210 may perform the power budget allocation by throttling the charging module 213. Hence, the circuit board temperature Tpcb_SPA rises slowly such that the electronic apparatus 200 is less likely to enter a thermal throttling mode. Even though the electronic apparatus 200 enters the thermal throttling mode (e.g. at a point in time t3), the processor module 211 may have enough computational power for processing the complex scenes C1-C3 because the controller 210 has throttled the charging module 213 in advance. Thus, the frame rate FPS_SPA is relatively stable.

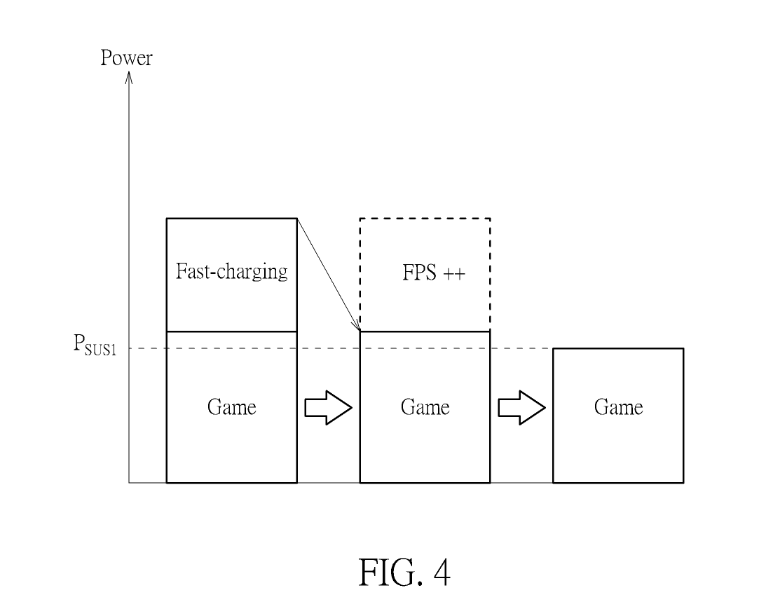

Please refer to FIG. 4 in conjunction with FIG. 3. FIG. 4 illustrates an exemplary system power associated with the power budget allocation shown in FIG. 3 according to an embodiment of the present invention. In this embodiment, when the power of the processor module 211 (current power consumption of the processor module 211) is not greater than a predetermined power P_{SUS1}, the electronic apparatus 200 is guaranteed not to trigger thermal throttling (e.g. the temperature of the chassis 202/the PCB 204 is guaranteed not to exceed a thermal threshold used for determining whether to trigger thermal throttling). In other words, when the power of the processor module 211 is not greater than the predetermined power P_{SUS1}, the user experience with the game application (or the primary user experience) is sustainable.

However, when the detected temperature of the electronic apparatus 200 is greater than a predetermined temperature (e.g. 40° C.) and the power of the processor module 211 is greater than the predetermined power P_{SUS1}, this means that the electronic apparatus 200 is likely to trigger thermal throttling (e.g. a difference between the temperature of the chassis 202/the PCB 204 and the thermal threshold for determining whether to trigger thermal throttling is less than a predetermined value), the controller 210 may determines that the user experience with the game application is likely to be degraded, and accordingly perform the power budget allocation. For example, the controller 210 may perform the power budget allocation by throttling a heat source associated with the secondary user experience. To put it differently, the controller 210 may throttle the charging module 213 to reduce power allocated to the charging module 213, such that at least part of power originally allocated to the fast-charging application may be released to the processor module 211 for maintaining a high frame rate required by the game application. It should be noted that, after throttling the fast-charging operation, power consumption and/or a temperature rise of the processor module 211 produced in response to the fast-charging application may decrease, and the power of the processor module 211 may be less than or equal to the predetermined power P_{SUS1} accordingly.

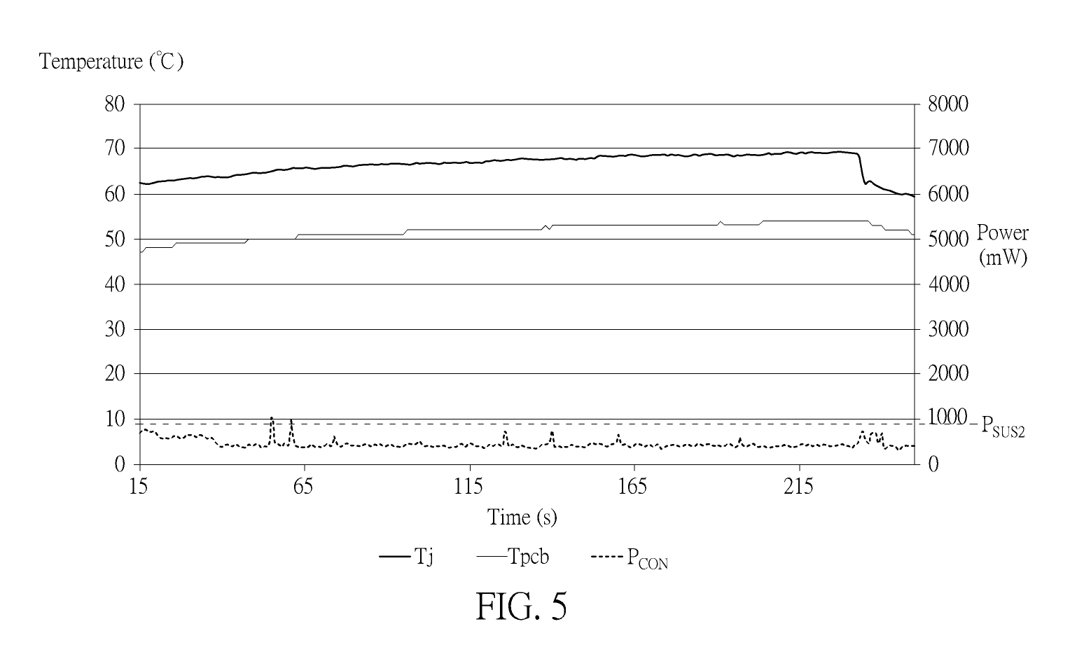

In addition to maintaining a primary user experience, the proposed power management mechanism may maximize a secondary user experience. Please refer to FIG. 5 in conjunction with FIG. 2. FIG. 5 illustrates variations in a circuit board temperature and power consumption in the electronic apparatus 200 shown in FIG. 2 according to an embodiment of the present invention. In this embodiment, the user activates a low power consumption application (e.g. a game imposing a light CPU/GPU load, or a video playback application) on the electronic apparatus 200 while charging the electronic apparatus 200, wherein the electronic apparatus 200 may utilize the processor module 211 to run the low power consumption application and utilize the charging module 213 to run a fast-charging application. The controller 210 may identify that the electronic apparatus 200 operates in an operating scenario where the low power consumption application and the fast-charging application are executed. Additionally, in a case where the electronic apparatus 200 has enough battery charge, the controller 210 may identify a user experience with the low power consumption application as a primary user experience of the electronic apparatus 200, and identify a user experience with the fast-charging application as a secondary user experience of the electronic apparatus 200.

In the embodiment shown in FIG. 5, as a power P_{CON} of the processing module 211 (e.g. current power consumption of the CPU within the processing module 211) is substantially less than a predetermined power P_{SUS2}, the controller 210 may determines that a user experience with the low power consumption application is sustainable. This means that the controller 210 may not need to throttle the charging module 213. Specifically, the controller 210 may maximize the secondary user experience (the user experience of the fast-charging application) while maintaining the primary user experience (the user experience with the low power consumption application).

In view of above, the proposed power management mechanism may dynamically allocate a limited power budget between a plurality of heat sources of an electronic apparatus before the electronic apparatus triggers thermal throttling. Hence, the proposed power management mechanism may not only maintain a primary user experience but also maximize a secondary user experience, thereby providing a good overall user experience of the electronic apparatus.

Please note that the above is for illustrative purposes only, and is not meant to be a limitation of the present invention. In an alternative design, a predetermined power used for determining whether a primary user experience of an electronic apparatus is sustainable may be greater than a power threshold corresponding to minimum acceptable system performance, ensuring that the electronic apparatus may not only avoid triggering thermal throttling but also meet performance requirements. In another alternative design, a predetermined power used for determining whether a primary user experience of an electronic apparatus is sustainable may be adjusted according different operating scenarios or applications. For example, a predetermined power corresponding to a high power consumption application (e.g. the predetermined power P_{SUS1} shown in FIG. 3) may be less than a low power consumption application (e.g. the predetermined power P_{SUS2} shown in FIG. 5).

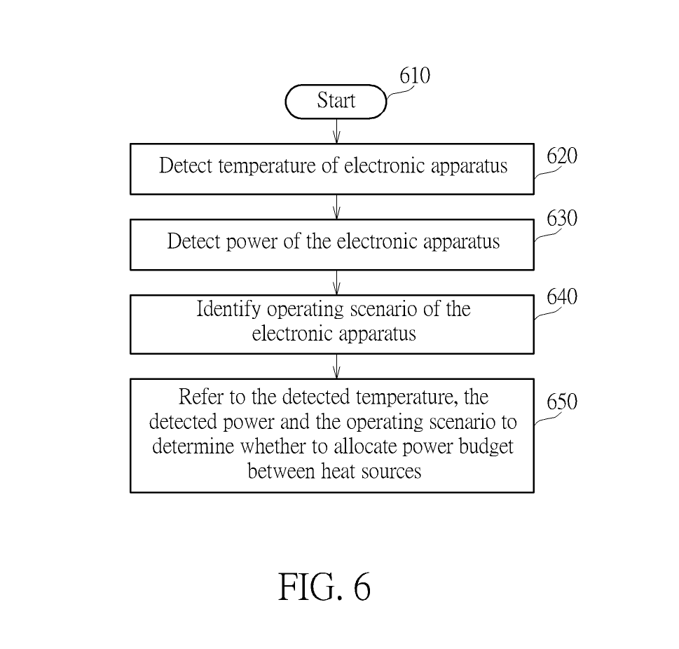

Further, the proposed power management mechanism may be summarized in FIG. 6. FIG. 6 is a flow chart of an exemplary power management method for an electronic apparatus according to an embodiment of the present invention, wherein the electronic apparatus may include a plurality of heat sources. Provided that the result is substantially the same, steps are not required to be executed in the exact order shown in FIG. 6. For example, steps can be added without departing from the scope of the present invention. In addition, the power management method shown in FIG. 6 is described with reference to the electronic apparatus 200 shown in FIG. 2 for illustrative purposes. This is not intended as a limitation of the present invention. It is possible to employ the power management method shown in FIG. 6 in the electronic apparatus 100 shown in FIG. 1 or other electronic apparatuses implemented based on the electronic apparatus 100 shown in FIG. 1. The power management method shown in FIG. 6 may be summarized below.

Step 610: Start.

Step 620: Detect a temperature of the electronic apparatus.

Step 630: Detect a power of the electronic apparatus.

Step 640: Identify an operating scenario of the electronic apparatus.

Step 650: Refer to the detected temperature, the detected power and the operating scenario to determine whether to allocate a power budget between the heat sources.

In step 620, the detected temperature may include a temperature of a chassis, a temperature of a circuit board, a junction temperature of a die/chip and/or a temperature of a battery device of the electronic apparatus. By way of example but not limitation, the electronic apparatus 200 may utilize at least one of the temperature sensors 221-226 to detect the temperature of the electronic apparatus 200.

In step 630, a power sensor such as a power meter may be utilized to measure the power of the electronic apparatus. It is possible to detect/calculate the power of the electronic apparatus according to system information of the electronic apparatus. By way of example but not limitation, the CPU of the processor module 211 may include a first cluster and a second cluster, wherein the first cluster may have four cores and operate at a frequency of 800 MHz, and the second cluster may have two cores and operate at a frequency of 2 GHz. The processor 211 may calculate current power consumption according to a current operating performance point (OPP). In one implementation, power consumption of a core of each cluster corresponding to different operating performance points may be shown in table 1 below.

TABLE 1

| OPP | Core of first cluster (mW) | Core of second cluster (mW) |
|---|---|---|
| OP0 | 400 | 900 |
| OP1 | 200 | 600 |
| OP2 | 100 | 400 |

For example, when the first cluster operates at an operating performance point OP2 and the second cluster operates at an operating performance point OP0, the processor module 211 may refer to table 1 to calculate the current power consumption, which equals to 2200 (100×4+900×2) mW. The electronic apparatus 200 may use as the calculated current power consumption as the detected power.

In one alternative design, the processor module 211 may further refer to a CPU load to calculate the current power consumption. For example, in a case where a CPU load of the first cluster equals to 360% and a CPU load of the second cluster equals to 180%, the calculated current power consumption will be 1980 (100×4×360/400+900×2×180/200) mW. In another alternative design, in addition to dynamic power consumption, the processor module 211 may further refer to static power consumption to obtain the current power consumption. For example, in a case where a CPU load of the first cluster equals to 360%, a CPU load of the second cluster equals to 180%, and CPU leakage power is 300 mW, the calculated current power consumption will be 2280 (1980+300) mW.

In step 640, the electronic apparatus may identify the operating scenario (a current operating scenario) according to the system information, wherein the operating scenario may be associated with execution of one or more applications. By way of example but not limitation, the electronic apparatus 200 may refer to power/temperature information (e.g. power/temperature information of at least one of the processor module 211, the WiFi module 212, the charging module 213, the modem module 214 and the backlight module 215), a frame rate, battery charge and/or an amount of data transmitted to identify if the operating scenario is associated with at least one of the a game application, a charging application, a camera application for picture taking or video recording, a video playback application and a WiFi tethering application.

In step 650, the electronic apparatus may refer to at least one of the detected temperature, the detected power and the operating scenario to determine if a user experience with an application on the electronic apparatus is likely to be degraded, thereby determining whether to allocate the power budget between the heat sources. In one implementation, the electronic apparatus may determine if the operating scenario is a predetermined scenario, and accordingly determine if the user experience with the application is likely to be degraded. Byway of example but not limitation, when the electronic apparatus 200 operates in a predetermined scenario such as a low battery scenario or a camera scenario (a camera application is activated) such that the user experience with the application is likely to be degraded, the electronic apparatus 200 may determine to perform power budget allocation (e.g. increasing power allocated to the charging module 213 when the predetermined scenario is the low battery scenario, or increasing power allocated to the processor module 211 when the predetermined scenario is the camera scenario) to maintain a good overall user experience.

In another implementation, the electronic apparatus may determine if a rate of change of the detected temperature is greater than a predetermined rate, and accordingly determine if the user experience with the application is likely to be degraded. By way of example but not limitation, when the controller 210 determines that a rate of change of the die junction temperature of the processor module 211 is greater than a predetermined rate, the temperature of the chassis 202 (or the PCB 204) may increase rapidly such that the electronic apparatus 200 is likely to trigger thermal throttling to reduce operating performance. Hence, the controller 210 may refer to at least the rate of change of the die junction temperature of the processor module 211 to determine if the user experience is likely to be degraded.

In yet another implementation, the electronic apparatus may firstly determine if the operating scenario is a predetermined scenario, wherein after it is determined that the operating scenario is not the predetermined scenario, the electronic apparatus may determine if a rate of change of the detected temperature is greater than a predetermined rate, or determine if the detected temperature is greater than a predetermined temperature, thereby determining if the user experience with the application is likely to be degraded.

Further, in a case where the electronic apparatus utilizes a first heat source of the heat sources to run the application, when it is determined that the user experience with the application is likely to be degraded, the electronic apparatus may throttle a second heat source of the heat sources to allocate the power budget between the heat sources, wherein the first heat source is more required than the second heat source to run the application.

As a person skilled in the art should understand the operation of each step shown in FIG. 6 after reading the above paragraphs directed to FIGS. 1-5, further description is omitted here for brevity.

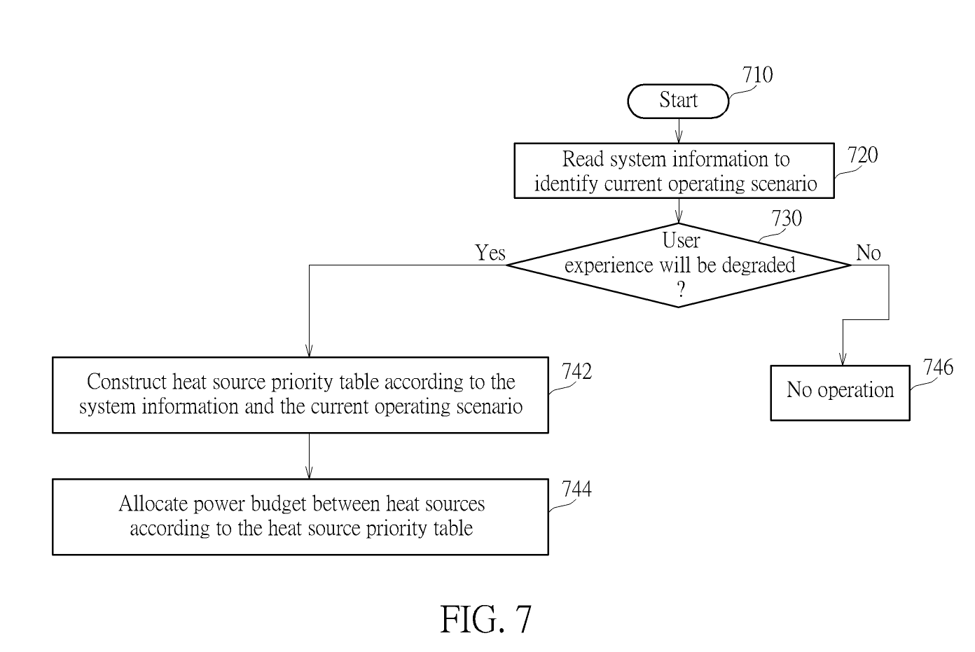

It should be noted that when determining to allocate the power budget between the heat sources, the proposed power management mechanism may further determine a heat source priority according to the system information and the current operating scenario, and allocate the power budget between the heat sources according to the heat source priority. Please refer to FIG. 7, which is a flow chart of an exemplary power management method for an electronic apparatus according to an embodiment of the present invention, wherein the electronic apparatus may include a plurality of heat sources. For illustrative purposes, the power management method shown in FIG. 7 is described with reference to the electronic apparatus 100 shown in FIG. 1. However, this is not intended as a limitation of the present invention. It is possible to employ the power management method shown in FIG. 7 in the electronic apparatus 200 shown in FIG. 2 or other electronic apparatuses implemented based on the electronic apparatus 100 shown in FIG. 1. The power management method shown in FIG. 7 may be summarized below.

Step 710: Start.

Step 720: Read system information of the electronic apparatus to identify a current operating scenario of the electronic apparatus. For example, the SPA circuit 130 may read the system information of the electronic apparatus 100 (e.g. power information, temperature information, a frame rate, battery charge and/or an amount of data transmitted) to identify the operating scenario SR of the electronic apparatus 100.

Step 730: Refer to the system information and the identified operating scenario to determine if a user experience with an application on the electronic apparatus is likely to de degraded. If yes, go to step 742; otherwise, go to step 746. For example, the SPA circuit 130 may refer to the operating scenario SR and the system information of the electronic apparatus 100 to determine if a user experience with an application on the electronic apparatus 100 (e.g. a primary user experience, or a user experience with a foreground application) is likely to de degraded, and accordingly determine whether to allocate the power budget between the heat sources HS₁-HS_{N}.

Step 742: Construct a heat source priority table according to the current operating scenario. For example, the SPA circuit 130 may construct/generate a heat source priority table PR according to the operating scenario SR, wherein the heat source priority table PR may indicate a priority order of usage of one or multiple heat sources required to maintain the user experience with the application.

Step 744: Allocate power budget between the heat sources according to the heat source priority table. For example, the SPA circuit 130 may allocate the power budget between the heat sources HS₁-HS_{N} according to the heat source priority table PR.

Step 746: Do not adjust power allocated to the heat sources. In other words, no power budget allocation operation is performed.

In step 730, the SPA circuit 130 may refer to at least the detected temperature TD and the operating scenario SR to determine if the user experience with the application on the electronic apparatus 100 is likely to be degraded, thereby determining whether to allocate the power budget between the heat sources HS₁-HS_{N}. In an alternative design, the SPA circuit 130 may refer to the detected temperature TD, the detected power PD and the operating scenario SR to determine if the user experience with the application on the electronic apparatus 100 is likely to be degraded.

In step 742, a high priority heat source in the heat source priority table PR may be a heat source highly related to the execution of the application. By way of example but not limitation, in a case where the electronic apparatus 100 operates in the operating scenario SR where a game application and a fast-charging application are executed, and the operating scenario SR (or the system information) indicates that the electronic apparatus 100 has enough battery charge, the heat source priority table PR may indicate that a heat source used to execute the game application (e.g. a processor module including a CPU and a GPU) has a higher priority than a heat source used to execute the fast-charging application (e.g. a charging module). Hence, in step 744, the SPA circuit 130 may throttle the heat source associated with the fast-charging application to increase power allocated to the heat source associated with the game application, thereby maintaining the user experience with the game application.

In another example, in a case where the electronic apparatus 100 operates in the operating scenario SR where a game application and a fast-charging application are executed, and the operating scenario SR (or the system information) indicates that the electronic apparatus 100 has low battery, the heat source priority table PR may indicate that the heat source used to execute the fast-charging application (e.g. a charging module) has a higher priority than the heat source used to execute the game application (e.g. a processor module including a CPU and a GPU). Hence, in step 744, the SPA circuit 130 may throttle the heat source associated with the game application to increase power allocated to the heat source associated with the fast-charging application, thereby ensuring normal operations of the electronic apparatus 100.

In step 746, the SPA circuit may not adjust power allocated to the heat sources HS₁-HS_{N}. In other words, the electronic apparatus 100 may refer to respective temperature detection results of the heat sources HS₁-HS_{N} (e.g. temperature detection results of the temperature sensors 221-225) to determine whether to throttle the heat sources HS₁-HS_{N}, respectively.

Please note that, if the result is substantially the same, steps are not required to be executed in the exact order shown in FIG. 7. For example, after identifying the current operating scenario (step 720), the proposed power management method may construct the heat source priority table (step 742) before determining if the user experience with the application on the electronic apparatus is likely to de degraded (step 730).

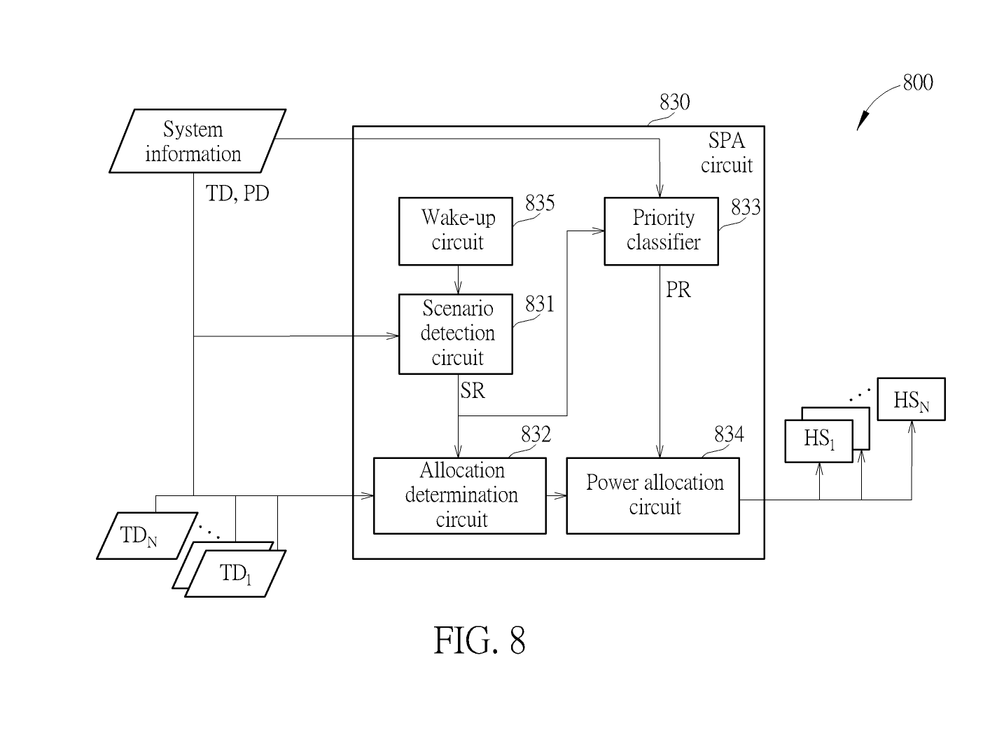

To facilitate an understanding of the present invention, an exemplary implementation is given in the following for further description of the proposed power budget allocation. However, this is not meant to be a limitation of the present invention. Please refer to FIG. 8 in conjunction with FIG. 1. FIG. 8 is an implementation of the electronic apparatus 100 shown in FIG. 1. The electronic apparatus 800 may include the heat sources HS₁-HS_{N} shown in FIG. 1 and a SPA circuit 830, wherein the SPA circuit 130 shown in FIG. 1 may be implemented by the SPA circuit 830. The SPA circuit 830 may receive system information of the electronic apparatus 800 to selectively allocate a power budget between the heat sources HS₁-HS_{N}, wherein the system information may indicate, but is not limited to, the detected temperature TD (e.g. generated by the temperature sensor 110 shown in FIG. 1; not shown), the detected power PD (e.g. generated by the power sensor 120 shown in FIG. 1; not shown), a frame rate, battery charge and an amount of data transmitted. In this embodiment, the SPA circuit 830 may include, but is not limited to, a scenario detection circuit 831, an allocation determination circuit 832, a priority classifier 833, a power allocation circuit 834 and a wake-up circuit 835.

The scenario detection circuit 831 may identify the operating scenario SR according to the system information, the allocation determination circuit 832 may determine whether to allocate the power budget according to the system information and the operating scenario SR, and the priority classifier 833 may generate/determine the heat source priority table PR according to the system information and the operating scenario SR. When the allocation determination circuit 832 determines to allocate the power budget, the power allocation circuit 834 may allocate the power budget between the heat sources HS₁-HS_{N} (e.g. setting power constraints of the heat sources HS₁-HS_{N}) according to the heat source priority table PR. In addition, the wake-up circuit 835 may activate the scenario detection circuit 831 periodically or aperiodically.

In one implementation, the scenario detection circuit 831 may receive temperature detection results TD₁-TD_{N} of the heat sources HS₁-HS_{N} (e.g. the temperature detection results of the temperature sensors 221-225 shown in FIG. 2), wherein the temperature detection results TD₁-TD_{N} may help the scenario detection circuit 831 identify the operating scenario SR. In another implementation, the allocation determination circuit 832 may receive the temperature detection results TD₁-TD_{N}, which may help determine whether to allocate the power budget. In yet another implementation, the temperature detection results TD₁-TD_{N} may be included in the system information.

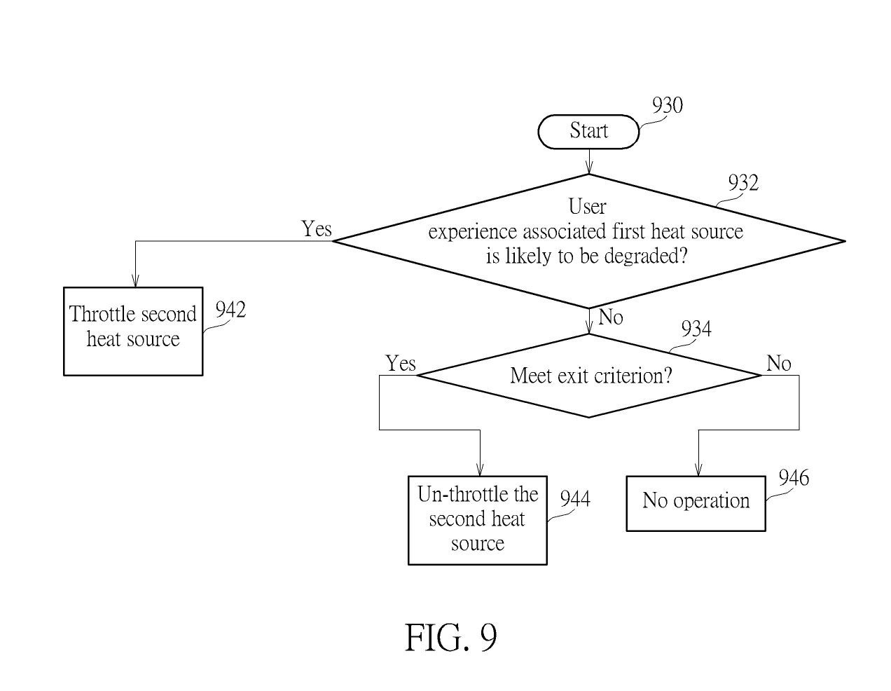

Please refer to FIG. 9 in conjunction with FIG. 8. FIG. 9 is a flow chart of an exemplary method employed by the SPA circuit 830 shown in FIG. 8 to determine whether to allocate the power budget according to an embodiment of the present invention. The method shown in FIG. 9 may be summarized below.

Step 930: Start. For example, the allocation determination circuit 832 may receive the system information (including the detected temperature TD and the detected power PD) and the operating scenario SR.

Step 932: The allocation determination circuit 832 may refer to the system information and the operating scenario SR to determine if a user experience associated with a first heat source of the heat sources HS₁-HS_{N} is likely to be degraded. If yes, go to step 942; otherwise, go to step 934.

Step 934: The allocation determination circuit 832 may refer to the system information and the operating scenario SR to determine if the electronic apparatus 800 meets an exit criterion. If yes, go to step 944; otherwise, go to step 946.

Step 942: The allocation determination circuit 832 may instruct the power allocation circuit 834 to throttle a second heat source of the heat sources HS₁-HS_{N}.

Step 944: The allocation determination circuit 832 may instruct the power allocation circuit 834 to unthrottle the second heat source. For example, in a case where the second heat source has been throttled, when the allocation determination circuit 832 determines that the electronic apparatus 800 meets the exit criterion and that there is no need to keep throttling the second source, the allocation determination circuit 832 may instruct the power allocation circuit 834 to unthrottle the second source.

Step 946: Do not adjust power allocated to the heat sources HS₁-HS_{N}. In other words, in a case where the user experience associated with the first heat source is not likely to be degraded and the electronic apparatus 800 does not meet the exit criterion, the SPA circuit 830 may not adjust power allocated to the heat sources HS₁-HS_{N}.

Please note that, if the result is substantially the same, steps are not required to be executed in the exact order shown in FIG. 9. In an alternative design, the SPA circuit 830 may refer to the method shown in FIG. 9 to continuously determine whether to allocate the power budget. For example, in a case where the electronic apparatus 800 utilizes the first heat source to run an application (a foreground application such as a game application), the allocation determination circuit 832 may determine if a user experience with the application (the user experience associated with the first heat source) is likely to be degraded (step 932). When it is determined that the user experience with the application is likely to be degraded (e.g. the first heat source suffers from a high CPU/GPU load when processing complex game scenes), the allocation determination circuit 832 may instruct the power allocation circuit 834 to throttle the second heat source in order to maintain the user experience with the application (step 942). Next, when the allocation determination circuit 832 determines that the electronic apparatus 800 meets the exit criterion (e.g. the first heat source places a light CPU/GPU load when processing simple game scenes), the allocation determination circuit 832 may instruct the power allocation circuit 834 to unthrottle the second heat source (step 934 and step 944).

In another alternative design, the allocation determination circuit 832 may firstly refer to the system information and the operating scenario SR to determine if the exit criterion is met (step 934). After it is determined that the exit criterion is not met, the allocation determination circuit 832 may determine if the user experience with the application is likely to be degraded (step 932), wherein when the exit criterion is not met, and the user experience with the application is not likely to be degraded, the SPA circuit 830 may not adjust power allocated to the heat sources HS₁-HS_{N} (step 946).

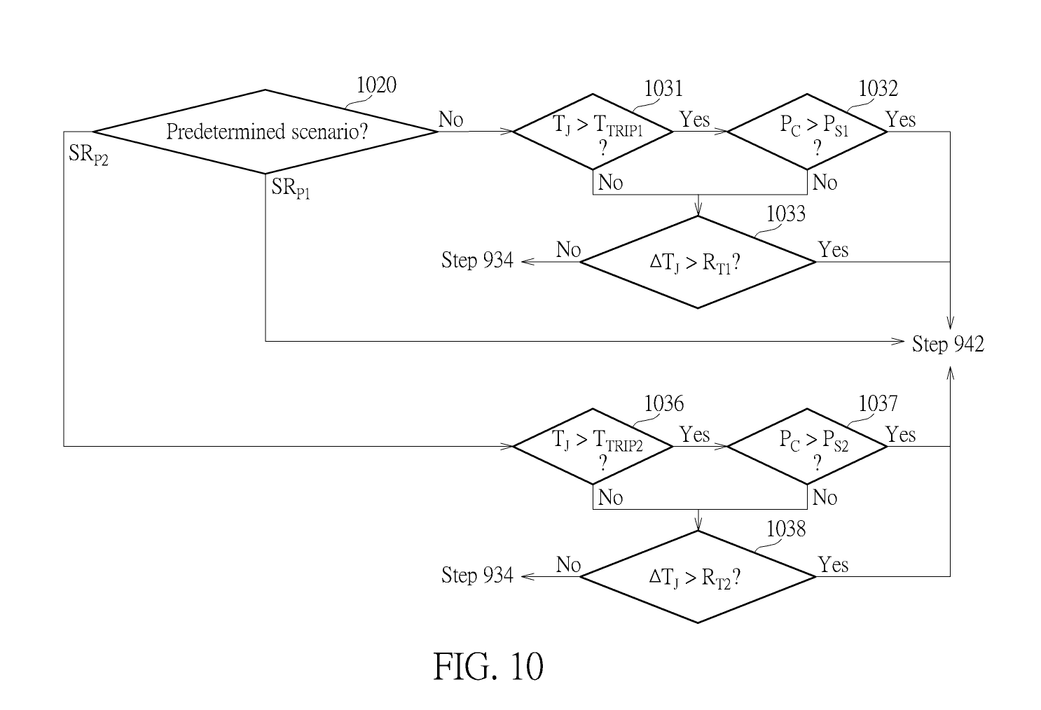

FIG. 10 is a flow chart illustrating an implementation of the step of determining if the user experience with the application is likely to be degraded shown in FIG. 9 (step 932) according to an embodiment of the present invention. For illustrative purposes, the method shown in FIG. 10 is described with the SPA circuit 830 shown in FIG. 8. In addition, the detected temperature TD shown in FIG. 8 may be a die junction temperature T_{J} of a processor module (one of the heat sources HS₁-HS_{N} such as the processor module 211 shown in FIG. 2), and the detected power PD shown in FIG. 8 may be a power P_{C} of the processor module. However, this is not intended as a limitation of the present invention.

First, in step 1020, the allocation determination circuit 832 may determine if the operating scenario SR is a predetermined scenario SR_{P1}. When it is determined that the operating scenario SR is the predetermined scenario SR_{P1}, the allocation determination circuit 832 may determine that the user experience with the application is likely to be degraded, and accordingly instruct the power allocation circuit 834 to throttle the second heat source to maintain the user experience associated with the first heat source (step 942).

In one implementation, the predetermined scenario SR_{P1} may be an operating scenario which enables the detected temperature TD to keep rising. For example, the predetermined scenario SR_{P1} may be a camera scenario where a camera application is activated. As continuous execution of the camera application may lead to an over temperature condition (the detected temperature TD or the die junction temperature T_{J} is too high) such that the user experience with the camera application is likely to be degraded, the allocation determination circuit 832 instruct the power allocation circuit 834 to throttle the second heat source in order to increase power allocated to the first heat source (e.g. the processor module).

In another implementation, the predetermined scenario SR_{P1} may be an operating scenario which enables the electronic apparatus 800 to stop working. For example, the predetermined scenario SR_{P1} may be a low battery scenario where battery charge is less than a predetermined percentage of battery capacity (e.g. 15%). As a user experience with one or more applications running on the electronic apparatus 800 is likely to be degraded in the low battery scenario where the electronic apparatus 800 is likely to shut down due to insufficient battery power. Hence, the allocation determination circuit 832 may instruct the power allocation circuit 834 to throttle the second heat source in order to increase power allocated to the first heat source (e.g. the charging module).

When it is determined that the operating scenario SR is not the predetermined scenario SR_{P1}, the allocation determination circuit 832 may refer to at least the die junction temperature T_{J} (the detected temperature TD) to determine if the user experience with the application is likely to be degraded. In one implementation, the allocation determination circuit 832 may determine if a rate of change ΔT_{J} of the die junction temperature T_{J} is greater than a predetermined rate (e.g. 10° C./s), wherein when the rate of change ΔT_{J} is greater than the predetermined rate, the allocation determination circuit 832 may determine that the user experience with the application is likely to be degraded. For example, the allocation determination circuit 832 may determine if the rate of change ΔT_{J} is greater than a predetermined rate R_{T1}. When the rate of change ΔT_{J} is greater than the predetermined rate R_{T1} (step 1033) the allocation determination circuit 832 may instruct the power allocation circuit 834 to throttle the second heat source in order to maintain the user experience with the application (step 942); when the rate of change ΔT_{J} is not greater than the predetermined rate R_{T1} the allocation determination circuit 832 may determine that the user experience with the application is sustainable, and then determine if the exit criterion is met (step 934).

In another implementation, the allocation determination circuit 832 may determine if the die junction temperature T_{J} is greater than a predetermined temperature and the power P_{C} is greater than a predetermined power, wherein when the die junction temperature T_{J} is greater than the predetermined temperature and the power P_{C} is greater than the predetermined power, the allocation determination circuit 832 may determine that the user experience with the application is likely to be degraded. For example, the allocation determination circuit 832 may determine if the die junction temperature T_{J} is greater than a predetermined temperature T_{TRIP1} and the power P_{C} is greater than a predetermined power P_{S1} (step 1031 and step 1032), wherein when the die junction temperature T_{J} is greater than the predetermined temperature T_{TRIP1} and the power P_{C} is greater than the predetermined power P_{S1}, the allocation determination circuit 832 may determine that the user experience with the application is likely to be degraded, and instruct the power allocation circuit 834 to throttle the second heat source (step 942). Additionally, in the embodiment shown in FIG. 10, after it is determined that the die junction temperature T_{J} is not greater than the predetermined temperature T_{TRIP1} and the power P_{C} is not greater than the predetermined power P_{S1}, the allocation determination circuit 832 may determine if the rate of change ΔT_{J} of the die junction temperature T_{J} is greater than the predetermined rate R_{T1} (step 1033).

As different operating scenarios, each of which is different from the predetermined scenario SR_{P1}, may correspond to different criteria for triggering thermal throttling, the allocation determination circuit 832 may refer to different operating scenarios to determine at least one of the aforementioned predetermined rate of change, predetermined temperature and predetermined power. Byway of example but not limitation, when it is determined that the operating scenario SR is a predetermined scenario SR_{P2} different from the predetermined scenario SR_{P1} (e.g. a high ambient temperature scenario where an ambient temperature exceeds a specific temperature such as 60° C.), the allocation determination circuit 832 may determine if the die junction temperature T_{J} is greater than a predetermined temperature T_{TRIP2} and the power P_{C} is greater than a predetermined power P_{S2} to thereby determine if the user experience is likely to be degraded (step 1036 and step 1037), wherein the predetermined temperature T_{TRIP2} (e.g. 55° C.) may be less than the predetermined temperature T_{TRIP1} (e.g. 60° C.), and the predetermined power P_{S2} (e.g. 600 mW) may be less than the predetermined power P_{S1} (e.g. 900 mW). In another example, it is determined that the operating scenario SR is the predetermined scenario SR_{P2} (e.g. a high ambient temperature scenario), the allocation determination circuit 832 may determine if the rate of change ΔT_{J} is greater than a predetermined rate R_{T2} to thereby determine if the user experience is likely to be degraded (step 1038), wherein the predetermined rate R_{T2} may be different from (e.g. less than) the predetermined rate R_{T1}.

In brief, when it is determined that the user experience with the application is likely to be degraded and the operating scenario SR is the predetermined scenario SR_{P2}, the aforementioned predetermined temperature may equal to a first temperature threshold and the aforementioned predetermined power may equal to a first power threshold; when it is determined that the user experience with the application is likely to be degraded and the operating scenario SR is neither the predetermined scenario SR_{P1} nor the predetermined scenario SR_{P2}, the aforementioned predetermined temperature may equal to a second temperature threshold greater than the first temperature threshold, and the aforementioned predetermined power may equal to a second power threshold greater than the first power threshold.

The above is for illustrative purposes only and is not meant to be a limitation of the present invention. In some embodiments, the predetermined rate R_{T1} associated with the predetermined scenario SR_{P1} may equal to the predetermined rate R_{T2} associated with the predetermined scenario SR_{P2}. Additionally, provided that the result is substantially the same, steps are not required to be executed in the exact order shown in FIG. 10. In an alternative design, step 1033 may be executed before step 1031, and/or step 1038 may be executed before step 1036. In another alternative design, step 1032 may be executed before step 1031, and/or step 1037 may be executed before step 1036.

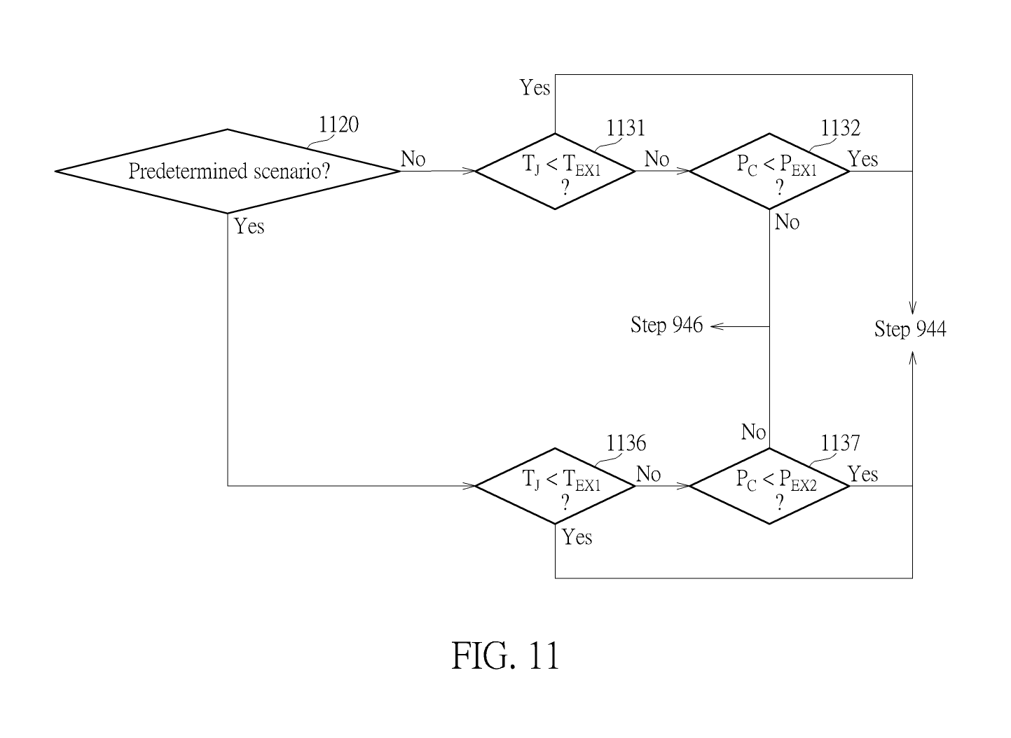

FIG. 11 is a flow chart illustrating an implementation of the step of determining if the exit criterion is met shown in FIG. 9 (step 934) according to an embodiment of the present invention. For illustrative purposes, the method shown in FIG. 11 is described with the SPA circuit 830 shown in FIG. 8. In addition, the detected temperature TD shown in FIG. 8 may be the die junction temperature T_{J} of the processor module (one of the heat sources HS₁-HS_{N} such as the processor module 211 shown in FIG. 2), and the detected power PD shown in FIG. 8 may be the power P_{C} of the processor module. However, this is not intended as a limitation of the present invention.

In this embodiment, the allocation determination circuit 832 may determine if the die junction temperature T_{J} is less than a predetermined temperature or the power P_{C} is less than a predetermined power, wherein when it is determined that the die junction temperature T_{J} is less than the predetermined temperature or the power P_{C} is less than the predetermined power, the allocation determination circuit 832 may determine that the exit criterion is met. For example, the allocation determination circuit 832 may determine if the die junction temperature T_{J} is less than a predetermined temperature T_{EX1} or the power P_{C} is less than a predetermined power P_{EX1} (step 1131 and step 1132), wherein when it is determined that the die junction temperature T_{J} is less than the predetermined temperature T_{EX1} or the power P_{C} is less than the predetermined power P_{EX1}, the allocation determination circuit 832 may determine that the exit criterion is met, and instruct the power allocation circuit 834 to unthrottle the second heat source (step 944). In addition, when it is determined that the die junction temperature T_{J} is not less than the predetermined temperature T_{EX1} and the power P_{C} is not less than the predetermined power P_{EX1}, the allocation determination circuit 832 may not adjust power allocated to the heat sources HS₁-HS_{N} (step 946).

As different operating scenarios may correspond to different criteria for triggering thermal throttling, the allocation determination circuit 832 may refer to different operating scenarios to determine at least one of the aforementioned predetermined temperature and predetermined power. For example, the allocation determination circuit 832 may firstly determine if the operating scenario SR is a predetermined scenario such as a high ambient temperature scenario (step 1120). After determining that the operating scenario SR is the predetermined scenario, the allocation determination circuit 832 may determine if the die junction temperature T_{J} is less than a predetermined temperature T_{EX2} or the power P_{C} is less than a predetermined power P_{EX2} to thereby determine whether the exit criterion is met (step 1136 and step 1137), wherein the predetermined temperature T_{EX2} may be less than the predetermined temperature T_{EX1}, and the predetermined power P_{EX2} may be less than the predetermined power P_{EX1}.

In brief, when it is determined that the exit criterion is met and the operating scenario SR is the predetermined scenario, the aforementioned predetermined temperature may equal to a first temperature threshold and the aforementioned predetermined power may equal to a first power threshold; when it is determined that the exit criterion is met and the operating scenario SR is not the predetermined scenario, the aforementioned predetermined temperature may equal to a second temperature threshold greater than the first temperature threshold, and the aforementioned predetermined power may equal to a second power threshold greater than the first power threshold.

The above is for illustrative purposes only and is not meant to be a limitation of the present invention. For example, provided that the result is substantially the same, steps are not required to be executed in the exact order shown in FIG. 11. In an alternative design, step 1132 may be executed before step 1131. In another alternative design, step 1137 may be executed before step 1136. Furthermore, a predetermined temperature used for determining whether the exit criterion is met may be less than or equal to a predetermined temperature used for determining whether the user experience is likely to be degraded. For example, the predetermined temperature T_{EX1} shown in FIG. 11 (e.g. 55° C.) may be less than the predetermined temperature T_{TRIP1} shown in FIG. 10 (e.g. 60° C.), and/or the predetermined temperature T_{EX2} shown in FIG. 11 (e.g. 50° C.) may be less than the predetermined temperature T_{TRIP2} shown in FIG. 10 (e.g. 55° C.). Moreover, a predetermined power used for determining whether the exit criterion is met may be less than or equal to a predetermined power used for determining whether the user experience is likely to be degraded. For example, the predetermined power P_{EX1} shown in FIG. 11 may be equal to the predetermined power P_{S1} shown in FIG. 10 (e.g. 900 mW), and/or the predetermined power P_{EX2} shown in FIG. 11 may be equal to the predetermined power P_{S2} shown in FIG. 10 (e.g. 600 mW).

As mentioned above, before performing power budget allocation, the proposed power management mechanism may refer to the identified operating scenario to determine a heat source priority. Please refer to FIG. 8 again. In this embodiment, the priority classifier 833 may classify heat sources into different priority levels according requirements of an executed foreground application. For example, the priority classifier 833 may classify heat sources into a first priority level PC1, a second priority level PC2 and a third priority level PC3, wherein a heat source having the first priority level PC1 is highly related to the foreground application, a heat source having the second priority level PC2 is related to at least one background application, and a heat source having the third priority level PC3 is not related to the foreground application and the at least one background application. Hence, in order to maintain a user experience of the executed foreground application (i.e. a primary user experience), the system power budget of the electronic apparatus 800 may be preferably allocated to a heat source having the first priority level PC1, and the electronic apparatus 800 may preferably throttle a heat source having the third priority level PC3 (or a heat source having the second priority level PC2) to increase power allocated to other heat source(s).

Next, the priority classifier 833 may refer to the operating scenario SR to determine respective priority levels of the heat sources HS₁-HS_{N}, and accordingly generate the heat source priority table PR. In one example where the heat sources HS₁-HS_{N} may include a processor module (e.g. the processor module 211 shown in FIG. 2), a network module (e.g. the WiFi module 212 and/or the modem module 214 shown in FIG. 2) and a charging module (e.g. the charging module 213 shown in FIG. 2), respective priority levels of the processor module, the network module and the charging module may be shown in table 2 below, wherein table 2 further shows priority classification corresponding to an operating scenario where power budget allocation does not start.

TABLE 2

| | Processor | | |
|---|---|---|---|
| Operating scenario | module | Network module | Charging module |
| SPA does not start | PC1 | PC1 | PC1 |
| Low battery | PC2 | PC2 | PC1 |
| scenario | | | |
| Other scenarios | PC1 | PC2 | PC3 |

As the same application(s) may be classified as different priority levels in different operating scenarios, the heat source priority table PR generated by the priority classifier 833 may have different contents in response to different operating scenarios. Take table 2 as an example, in a case where the electronic apparatus 800 determines to start power budget allocation and the battery charge thereof is less than a threshold such as 15% of battery capacity (i.e. a low battery scenario), the heat source priority table PR may be a specific heat source priority table, which indicates that the charging module has the first priority level PC1 and each of the processor module and the network module has the second priority level PC2. In another case where the electronic apparatus 800 determines to start power budget allocation and the battery charge thereof is sufficient, the heat source priority table PR may be a default heat source priority table, which indicates that the processor module has the first priority level PC1, the network module has the second priority level PC2 and the charging module has the third priority level PC3.

It should be noted that the priority classification shown in table 2 is for illustrative purposes only and is not meant to be a limitation of the present invention. For example, the content of the heat source priority table PR may be adjusted according to design requirements/considerations.

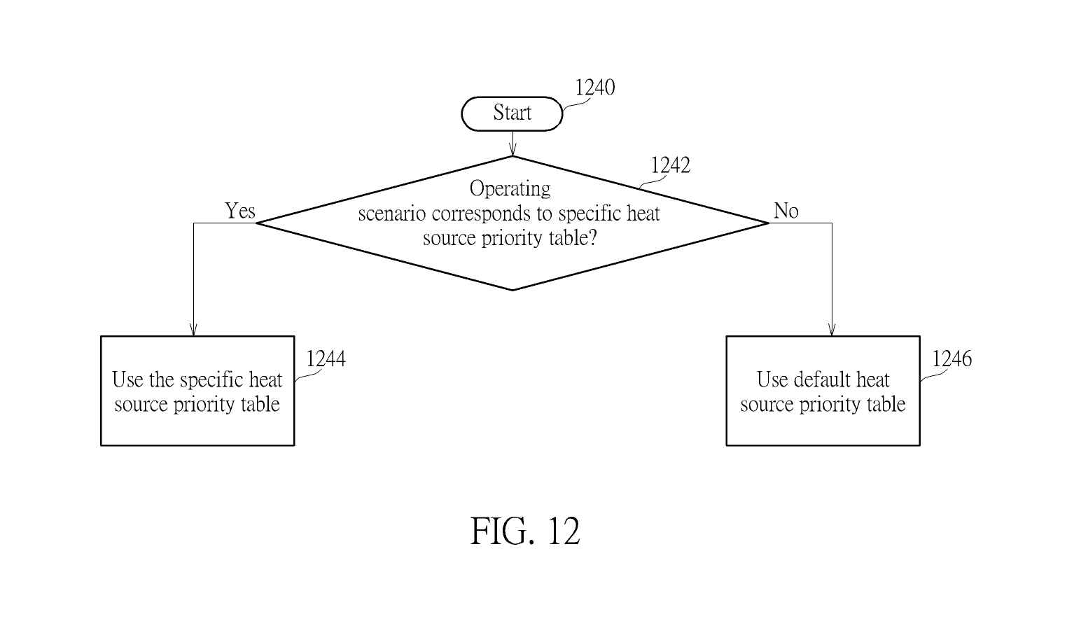

FIG. 12 is a flow chart illustrating an exemplary method for determining a heat source priority table according to an embodiment of the present invention. For illustrative purposes, the method shown in FIG. 12 is described with the SPA circuit 830 shown in FIG. 8. The method shown in FIG. 12 may be summarized below.

Step 1240: Start.

Step 1242: The priority classifier 833 may determine if the operating scenario SR corresponds to a specific heat source priority table. If yes, go to step 1244; otherwise, go to step 1246. By way of example but not limitation, when the operating scenario SR is a low battery scenario, the priority classifier 833 may determine that the operating scenario SR corresponds to a specific heat source priority table (e.g. the specific heat source priority table shown in table 2 which indicates the charging module has the first priority level PC1); when the operating scenario SR is the low battery scenario, the priority classifier 833 may determine that the operating scenario SR corresponds to a default heat source priority table (e.g. the default heat source priority table shown in table 2 which indicates the charging module has the third priority level PC3).

Step 1244: The priority classifier 833 may use the specific heat source priority table as the heat source priority table PR provided to the power allocation circuit 834.

Step 1246: The priority classifier 833 may use the default heat source priority table as the heat source priority table PR provided to the power allocation circuit 834.

As a person skilled in the art should understand the operation of each step shown in FIG. 12 after reading the above paragraphs directed to FIG. 8 and table 2, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management method for an electronic apparatus, the electronic apparatus comprising a plurality of heat sources, the power management method comprising:
detecting a temperature of the electronic apparatus;
detecting a power of the electronic apparatus;
identifying an operating scenario of the electronic apparatus; and
referring to the detected temperature, the detected power and the operating scenario to determine whether to allocate a power budget between the heat sources.

2. The power management method of claim 1, wherein the step of referring to the detected temperature, the detected power and the operating scenario to determine whether to allocate the power budget between the heat sources comprises:
referring to at least the detected temperature and the operating scenario to determine if a user experience with an application on the electronic apparatus is likely to be degraded, wherein the electronic apparatus uses a first heat source of the heat sources to run the application.

3. The power management method of claim 2, wherein when it is determined that the user experience with the application is likely to be degraded, the power management method further comprises:
throttling a second heat source of the heat sources to allocate the power budget between the heat sources, wherein the first heat source is more required than the second heat source to run the application.

4. The power management method of claim 3, wherein the step of throttling the second heat source of the heat sources to allocate the power budget between the heat sources comprises:
generating a heat source priority table according to the operating scenario, and determining the second heat source according to the heat source priority table, wherein the priority table indicates that the first heat source has a higher priority than the second heat source.

5. The power management method of claim 2, wherein referring to at least the detected temperature and the operating scenario to determine if the user experience with the application is likely to be degraded comprises:
when the operating scenario is a first predetermined scenario, it is determined that the user experience with the application is likely to be degraded; and
when the operating scenario is not the first predetermined scenario, referring to at least the detected temperature to determine if the user experience with the application is likely to be degraded.

6. The power management method of claim 5, wherein when the first predetermined scenario is a camera scenario.

7. The power management method of claim 5, wherein referring to at least the detected temperature to determine if the user experience with the application is likely to be degraded comprises:
determining if a rate of change of the detected temperature is greater than a predetermined rate;
wherein when the rate of change of the detected temperature is greater than the predetermined rate, it is determined that the user experience with the application is likely to be degraded.

8. The power management method of claim 5, wherein referring to at least the detected temperature to determine if the user experience with the application is likely to be degraded comprises:
determining if the detected temperature is greater than a predetermined temperature and the detected power is greater than a predetermined power;
wherein when the detected temperature is greater than the predetermined temperature and the detected power is greater than the predetermined power, it is determined that the user experience with the application is likely to be degraded.

9. The power management method of claim 8, wherein the step of referring to at least the detected temperature to determine if the user experience with the application is likely to be degraded further comprises:
determining the predetermined temperature and the predetermined power according to the operating scenario;
wherein when the operating scenario is a second predetermined scenario, the predetermined temperature equals to a first temperature threshold, and the predetermined power equals to a first power threshold; and when the operating scenario is not the second predetermined scenario, the predetermined temperature equals to a second temperature threshold greater than the first temperature threshold, and the predetermined power equals to a second power threshold greater than the first power threshold.

10. The power management method of claim 9, wherein when the second predetermined scenario is a high ambient temperature scenario.

11. The power management method of claim 2, wherein when a second heat source of the heat sources is throttled, and it is determined that the user experience with the application is not likely to be degraded, the step of referring to the detected temperature, the detected power and the operating scenario to determine whether to allocate the power budget between the heat sources further comprises:
determining if the detected temperature is less than a predetermined temperature or the detected power is less than a predetermined power; and
when the detected temperature is less than the predetermined temperature or the detected power is less than the predetermined power, unthrottling the second heat source to allocate the power budget between the heat sources.

12. The power management method of claim 11, wherein the step of referring to the detected temperature, the detected power and the operating scenario to determine whether to allocate the power budget between the heat sources further comprises:
determining the predetermined temperature and the predetermined power according to the operating scenario;
wherein when the operating scenario is a predetermined scenario, the predetermined temperature equals to a first temperature threshold, and the predetermined power equals to a first power threshold; and when the operating scenario is not the predetermined scenario, the predetermined temperature equals to a second temperature threshold greater than the first temperature threshold, and the predetermined power equals to a second power threshold greater than the first power threshold.

13. The power management method of claim 12, wherein when the predetermined scenario is a high ambient temperature scenario.

14. The power management method of claim 1, wherein a heat source of the heat sources is throttled, and the step of referring to the detected temperature, the detected power and the operating scenario to determine whether to allocate the power budget between the heat sources comprises:
determining if the detected temperature is less than a predetermined temperature or the detected power is less than a predetermined power; and
when the detected temperature is less than the predetermined temperature or the detected power is less than the predetermined power, unthrottling the heat source to allocate the power budget between the heat sources.

15. The power management method of claim 14, wherein the step of referring to the detected temperature, the detected power and the operating scenario to determine whether to allocate the power budget between the heat sources further comprises:
determining the predetermined temperature and the predetermined power according to the operating scenario;
wherein when the operating scenario is a predetermined scenario, the predetermined temperature equals to a first temperature threshold, and the predetermined power equals to a first power threshold; and when the operating scenario is not the predetermined scenario, the predetermined temperature equals to a second temperature threshold greater than the first temperature threshold, and the predetermined power equals to a second power threshold greater than the first power threshold.

16. The power management method of claim 15, wherein when the predetermined scenario is a high ambient temperature scenario.

17. An electronic apparatus, comprising:
a plurality of heat sources;
a temperature sensor, for detecting a temperature of the electronic apparatus;
a power sensor, for detecting a power of the electronic apparatus; and
a system power allocation circuit, coupled to the heat sources, the temperature sensor and power sensor, the system power allocation circuit arranged for identifying an operating scenario of the electronic apparatus, and referring to the detected temperature, the detected power and the operating scenario to determine whether to allocate a power budget between the heat sources.

18. The power management method of claim 17, wherein the electronic apparatus uses a first heat source of the heat sources to run an application, and the system power allocation circuit refers to at least the detected temperature and the operating scenario to determine if a user experience with the application is likely to be degraded so as to determine whether to allocate the power budget between the heat sources.

19. The power management method of claim 18, wherein when it is determined that the user experience with the application is likely to be degraded, the system power allocation circuit throttles a second heat source of the heat sources to allocate the power budget between the heat sources; and the first heat source is more required than the second heat source to run the application.

20. The power management method of claim 17, wherein a heat source of the heat sources is throttled, and the system power allocation circuit determines if the detected temperature is less than a predetermined temperature or the detected power is less than a predetermined power so as to determine whether to allocate the power budget between the heat sources; and when the detected temperature is less than the predetermined temperature or the detected power is less than the predetermined power, the system power allocation circuit unthrottles the heat source to allocate the power budget between the heat sources.
